(19) United States
(12) Patent Application Publication
(10) Pub. No.: US 2010/0046260 A1
(43) Pub. Date: Feb. 25, 2010

(54) Feeding of output-side parallel connected bridge rectifiers with phase-shifted voltages from the secondary windings of at least one transformer

(76) Inventor: Roland Schuster, Mohrendorf (DE)

Correspondence Address: HARNESS, DICKEY & PIERCE, P.L.C., P.O.BOX 8910, RESTON, VA, 20195, US

(21) Appl. No.: 12/312,248

(22) PCT Filed: Oct. 9, 2007
(86) PCT No.: PCT/EP2007/060683

§ 371 Date: May 1, 2009

(30) Foreign Application Priority Data
Nov. 3, 2006 (DE) 10 2006 052 008.4

(51) Int. Cl. H02M 7/06

(52) U.S. Cl. 363/126

(57) ABSTRACT

A device is disclosed for generating DC voltage from AC voltage. The device includes parallel connected diode bridges which are fed via at least one transformer, the primary windings of which are connected in series. The DC voltage is used for supplying DC paths, and secondary voltages on the secondary windings of the transformer have different phase angles. This is achieved in at least the embodiment, e.g., by the fact that one secondary winding is connected in a delta configuration, and another secondary winding is connected in a star configuration.

### PRIORITY STATEMENT

This application is the national phase under 35 U.S.C. §371 of PCT International Application No. PCT/EP2007/060683 which has an International filing date of Oct. 9, 2007, designating the United States of America, which claims priority on German Application number 10 2006 052 008.4 filed Nov. 3, 2006, the entire contents of each of which are hereby incorporated herein by reference.

### FIELD OF THE INVENTION

At least one embodiment of the invention generally relates to an apparatus for production of DC voltage from AC voltage by way of parallel-connected diode bridges which are fed via at least one transformer whose primary windings are connected in series.

### BACKGROUND

An apparatus is known from DE-OS 1 438 613.

It is normal practice to provide one or more diode bridges, each having six diode arms, for rectification. Each of these so-called six-pulsed diode bridges is connected to a three-phase winding system of a transformer. Each diode arm of a diode bridge may comprise one diode or a plurality of parallel-connected diodes. Because of the required power, two diode bridges are frequently used, and feed the DC voltage network in parallel.

The three-phase AC voltage of the public network, which is a three-phase network, is, however, generally not ideally sinusoidal. In accordance with recognized rules of electrical engineering, permissible harmonics occur in three-phase networks in addition to the fundamental, and have a disturbing effect on rectifiers, and therefore also on the DC voltage that is produced. Depending on the amplitude and the phase angle of these harmonics, it is possible for the diode bridges to be subject to very different loads.

In order not to overload installations or components by such unbalanced loads, it has already been proposed for the installations to be designed for higher currents. This can be done, for example, by increasing the number of parallel-connected diodes in each diode arm. An apparatus for rectification such as this is large and complex.

Other variants of apparatuses for production of DC voltage from AC voltage, which envisage the use of controlled rectifiers, the series connection of diode bridges or the use of harmonic filters, are technically complex and therefore expensive.

### SUMMARY

At least one embodiment of the invention specifies an apparatus for production of DC voltage from AC voltage which provides a DC voltage that is smoothed as well as possible, with optimal utilization of all the components that are used, even when there are harmonics in the AC voltage that is fed in, without requiring larger, expensive diode bridges and also without additional costly electronic components.

According to at least one embodiment of the invention, the DC voltage is used to supply DC railroads, and secondary voltages on the secondary windings of the transformer have different phase shifts.

The transformer may have two or else more than two primary windings, which are connected in series.

Solely as a result of the fact that the secondary voltages on the secondary windings of the transformer have different phase shifts, that in conjunction with this that the primary windings of the transformer are connected in series, this results in the advantage that the harmonics of the AC voltage produce virtually no unbalance distribution of the current in the connected rectifier bridges. This results in a DC voltage which is smoothed as well as possible. A uniform distribution of the rectifier currents is achieved without the use of costly additional components, such as controlled rectifiers or harmonic filters. In particular, the diodes or diode bridges do not need to be derated. The DC voltage which is obtained in this way is advantageously particularly highly suitable for supplying DC railroads.

For example, the difference in the phase shifts is (2n−1)*30°. This advantageously results in a well-smoothed twelve-pulsed DC voltage, particularly when using two parallel-connected rectifier bridges and two winding systems of the transformer. The ripple on the DC voltage is based on twelve pulses rather than six pulses, as results when using only one diode bridge. The twelve-pulsed DC voltage has a considerably lower harmonic content than the six-pulsed DC voltage.

For example, the different phase shifts are achieved by connecting one secondary winding in delta and another secondary winding in star. The desired different phase shifts are therefore advantageously achieved using simple devices.

This results in particular in the advantage that the effects, which are particularly disturbing in the case of weak public networks with a high harmonic content, on the DC voltage and the unbalanced load on the components are overcome by means of a simple circuit. A well-smoothed DC voltage is made available in order to supply DC railroads, using simple devices. Solely as a result of the fact that secondary voltages on the secondary windings of the transformer have different phase shifts when the primary windings are connected in series, the negative effects of the harmonics from the three-phase network are largely avoided, and the components are uniformly loaded.

### BRIEF DESCRIPTION OF THE DRAWINGS

One embodiment of the apparatus for rectification will be explained in more detail with reference to the drawings, in which:

FIG. 1 shows one example of a transformer arrangement according to an embodiment of the invention, and

FIG. 2 shows a diode bridge, one of which is in each case connected to each secondary winding of the transformer.

### DETAILED DESCRIPTION OF THE EXAMPLE EMBODIMENTS

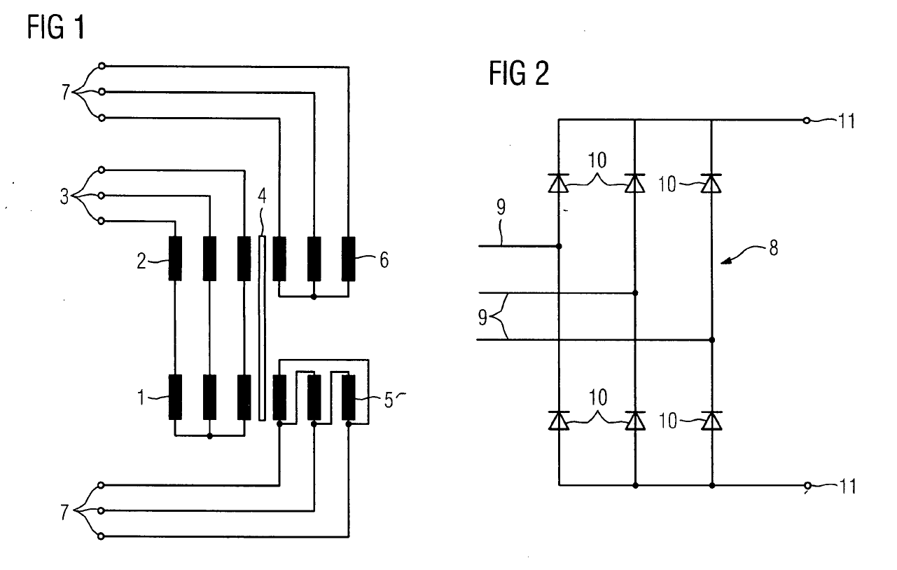

FIG. 1 schematically shows series-connected primary windings 1 and 2 of a transformer, to which the AC voltage from a public network is supplied at the connections 3. The primary windings 1 and 2 are associated with an iron core 4 and the secondary windings 5 and 6 of the transformer. In this case, the three windings of the first secondary winding 5 are connected in delta and the three windings of the second secondary winding 6 are connected in star.

A diode bridge 8, which is shown in FIG. 2, is connected via its connections 9 to each of the two secondary windings 5 and 6 via connections 7. The diode bridge 8 comprises three diode pairs, and therefore six diodes 10. The desired DC voltage is then produced at the output 11 of the diode bridge 8.

Good smoothing of the DC voltage and balanced distribution of the current between the two connected diode bridges are achieved, even in the event of major harmonics in the AC voltage, by way of the delta connection, as shown in FIG. 1, of the first secondary windings 5 in conjunction with the star connection of the second secondary winding 6 of the transformer. Advantageously, there is no need for an enlarged diode bridge and there is also no need for any additional components, for example a harmonic filter, in order to achieve a well-smoothed DC voltage.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An apparatus for production of DC voltage, suitable for supply to a DC railroad, from AC voltage, comprising:
at least one transformer including secondary windings and two series-connected primary windings, secondary voltages on the secondary windings of the transformer having different phase shifts; and
a parallel-connected diode bridge, including three diode pairs connected to the secondary windings of the at least one transformer to produce the DC voltage from the AC voltage fed from the at least one transformer, the DC voltage being suitable for supply to the DC railroads.

2. The apparatus as claimed in claim 1, wherein the difference in the phase shifts is (2n−1)*30°.

3. The apparatus as claimed in claim 1, wherein the different phase shifts are produced by connecting one secondary winding in a delta configuration, and by connecting another secondary winding in a star configuration.

4. The apparatus as claimed in claim 2, wherein the different phase shifts are produced by connecting one secondary winding in a delta configuration, and by connecting another secondary winding in a star configuration.
